(19) United States
(12) Patent Application Publication
(10) Pub. No.: US 2024/0351351 A1
(43) Pub. Date: Oct. 24, 2024

(54) HEATING DEVICE, DRYER APPARATUS, AND LIQUID APPLYING APPARATUS

(71) Applicants: Takayuki SEKI, Kanagawa (JP); Kenji NOZAWA, Kanagawa (JP); Kohki ASADA, Tokyo (JP); Genichiroh KAWAMICHI, Kanagawa (JP); Takehiro NAKAMURA, Kanagawa (JP); Hiroki ISHIHARA, Kanagawa (JP)

(72) Inventors: Takayuki SEKI, Kanagawa (JP); Kenji NOZAWA, Kanagawa (JP); Kohki ASADA, Tokyo (JP); Genichiroh KAWAMICHI, Kanagawa (JP); Takehiro NAKAMURA, Kanagawa (JP); Hiroki ISHIHARA, Kanagawa (JP)

(73) Assignee: Ricoh Company Ltd., (omitted)

(21) Appl. No.: 18/640,017

(22) Filed: Apr. 19, 2024

(30) Foreign Application Priority Data
Apr. 24, 2023 (JP) 2023-070564

(51) Int. Cl. B41J 11/00; B41J 29/13

(52) U.S. Cl. CPC B41J 11/0022; B41J 29/13

(57) ABSTRACT

A heating device includes a heater and a cover to cover the heater. In the heating device, the cover includes a first cover disposed in a first direction of the heater and a second cover disposed in the first direction, and the second cover is adjacent to the first cover. In the heating device, the first cover and the second cover have a gap in between, and the gap has a length greater than an amount of thermal deformation of either one of the first cover or the second cover or a total amount of thermal deformation of the first cover and the second cover.

### CROSS-REFERENCE TO RELATED APPLICATION

This patent application is based on and claims priority pursuant to 35 U.S.C. § 119 (a) to Japanese Patent Application No. 2023-070564, filed on Apr. 24, 2023, in the Japan Patent Office, the entire disclosure of which is hereby incorporated by reference herein.

### BACKGROUND

### Technical Field

Embodiments of the present disclosure relate to a heating device, a drier apparatus, and a liquid applying apparatus.

### Background Art

Heating devices have been proposed in which a plurality of heat irradiation units provided with heaters are arranged in the conveyance direction of a sheet.

In such heating devices, those multiple heat irradiation units are arranged in a housing. Further, inside the housing, each of the heat irradiation units is provided with a heater cover that covers a heater.

### SUMMARY

Embodiments of the present disclosure described herein provide a heating device, a drier apparatus, and a liquid applying apparatus. The heating device includes a heater and a cover to cover the heater. In the heating device, the cover includes a first cover disposed in a first direction of the heater and a second cover disposed in the first direction, and the second cover is adjacent to the first cover. In the heating device, the first cover and the second cover have a gap in between, and the gap has a length greater than an amount of thermal deformation of either one of the first cover or the second cover or a total amount of thermal deformation of the first cover and the second cover. The drier apparatus includes a drying device to dry an object to which liquid has been applied, and a plurality of heating devices including the heating device. The liquid applying apparatus includes a liquid applicator to apply a liquid to an object, and the drier apparatus to dry the object.

### BRIEF DESCRIPTION OF THE DRAWINGS

A more complete appreciation of embodiments and the many attendant advantages thereof will be readily obtained as the same becomes better understood by reference to the following detailed description when considered in connection with the accompanying drawings.

FIG. 1 is a schematic diagram of a liquid applying apparatus according to an embodiment of the present disclosure.

FIG. 2 is a schematic plan view of a liquid applying unit.

FIG. 3A, FIG. 3B, and FIG. 3C are schematic diagrams of a heating device according to a comparative example.

FIG. 4A and FIG. 4B are schematic diagrams each of which illustrates the airflow inside a drying device according to a comparative example.

FIG. 5A and FIG. 5B are schematic diagrams each of which illustrates the airflow inside a drying device according to a comparative example.

FIG. 6A and FIG. 6B are schematic diagrams of a heating device according to the first embodiment of the present disclosure.

FIG. 7 is a schematic diagram of a heating device according to the first embodiment of the present disclosure.

FIG. 8A and FIG. 8B are schematic diagrams of a heating device according to the second embodiment of the present disclosure.

FIG. 9A and FIG. 9B are schematic diagrams each of which illustrates a drier apparatus according to a modification of the above embodiments of the present disclosure.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to limit the present disclosure. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the present disclosure is not intended to be limited to the specific terminology so selected and it is to be understood that each specific element includes all technical equivalents that have the same structure, operate in a similar manner, and achieve a similar result.

Embodiments of the present disclosure are described below with reference to the accompanying drawings. In the description of the drawings, like reference signs denote like elements, and overlapping descriptions are omitted.

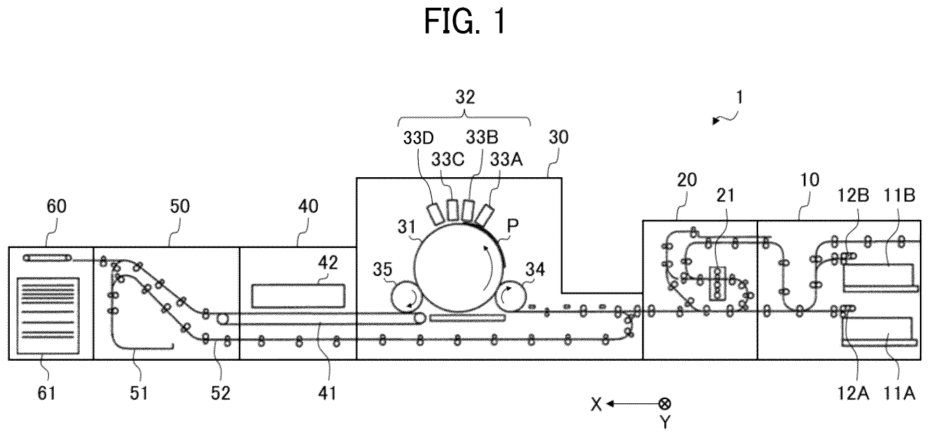

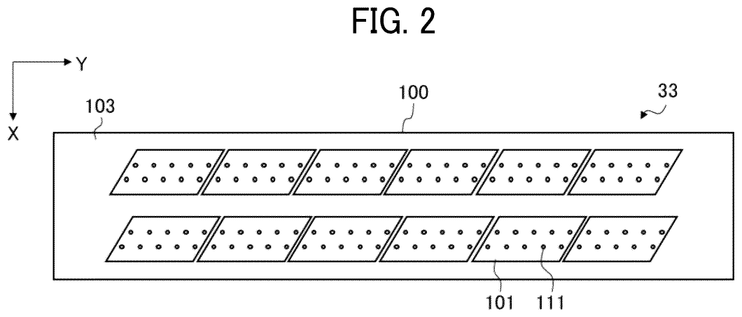

Firstly, a liquid applying apparatus is schematically described with reference to FIG. 1 and FIG. 2.

FIG. 1 is a schematic diagram of the liquid applying apparatus according to an embodiment of the present disclosure.

As the liquid applying apparatus, a printer 1 is described below by way of example.

FIG. 2 is a schematic plan view of a liquid applying unit 33 of the printer 1 of FIG. 1.

The printer 1 is provided with a loading unit 10, a preprocessor 20, a printer unit 30, a drier apparatus 40, a reversing mechanism 50, and a sheet ejection unit 60.

In the printer 1, the sheet P that is loaded or supplied from the loading unit 10 is conveyed in the X-axis direction, and the preprocessor 20 applies a pretreatment liquid to the sheets P loaded through the loading unit 10 as necessary. Moreover, the printer unit 30 applies the liquid to the sheet P as desired to perform printing as desired.

In the printer 1, after the liquid applied to the sheets Pis dried by the drier apparatus 40, the sheets P are ejected to the sheet ejection unit 60 as they are, or the sheets P are ejected to the sheet ejection unit 60 through the reversing mechanism 50 after printing is performed on both sides of each of the sheets P.

The loading unit 10 is provided with a pair of loading trays 11 including a lower loading tray 11A and an upper loading tray 11B to store a plurality of sheets P, and a pair of feeders 12 including a lower feeder 12A and an upper feeder 12B to feed the sheets P separately on a one-by-one basis from the loading trays 11. The loading unit 10 supplies the sheets P fed by the feeders 12 to the preprocessor 20.

The preprocessor 20 is provided with, for example, an applicator 21 that applies treatment liquid to a surface of the sheet P for the purposes of reforming the surface of the sheet P.

The printer unit 30 is provided with a drum 31 that bears the sheet P on its peripheral surface and rotates on the axis, and a liquid applying device 32 that applies liquid to the sheet P borne by the drum 31. The printer unit 30 includes a loading barrel 34 that receives the sheet P sent from the preprocessor 20 and passes the sheet P to the drum 31, and an unloading barrel 35 that receives the sheet P conveyed by the drum 31 and passes the sheet P to the drier apparatus 40.

The loading barrel 34 has a sheet gripper to grip the front end of the sheet P that is conveyed from the preprocessor 20 to the printer unit 30, and the sheet Pis conveyed as the loading barrel 34 rotates on the axis. The sheet P that is conveyed by the loading barrel 34 is passed to the drum 31 at a position facing the drum 31. The drum 31 also has a sheet gripper on its surface to grip the front end of the sheet P.

A plurality of suction holes are formed on the surface of the drum 31 in a distributed manner, and a suction mechanism generates a suction airflow directed inward from desired ones of the suction holes of the drum 31. The front end of the sheet P that is passed from the loading barrel 34 to the drum 31 is gripped by the sheet gripper. Moreover, the sheet P is sucked up and borne onto the drum 31 by the suction airflow generated by the suction mechanism, and is conveyed as the drum 31 rotates on the axis.

The liquid applying device 32 is provided with a plurality of liquid applying units 33 including liquid applying units 33A, 33B, 33C, and 33D. For example, the liquid applying unit 33A, the liquid applying unit 33B, the liquid applying unit 33C, and the liquid applying unit 33D apply liquid of cyan (C) color, liquid of magenta (M) color, liquid of yellow (Y) color, and liquid of black (BK) color, respectively. Alternatively, the liquid applying device 32 may use a liquid applying unit to apply a liquid of a special color such as white, gold, or silver. The liquid applying device 32 is an example of a liquid applicator.

The liquid applying unit 33 is provided with a head module 100 as illustrated in, for example, FIG. 2. The head module 100 has a base 103, and a plurality of heads 101 are attached to the base 103. Each of the heads 101 has a plurality of rows of nozzles composed of a plurality of nozzle holes 111. In the present embodiment, the number of rows of nozzles is five, and the number of nozzle holes 111 is two. Those heads 101 are arrayed in the Y-axis direction orthogonal to the X-axis direction to form a full-line head. In the present embodiment, the number of heads 101 is six. In the present embodiment, a pair of full-line heads are arranged in the X-axis direction, and the heads 101 are arranged in a staggered manner. However, no limitation is indicated thereby, and only one full-line head may be arranged, or three or more full-line heads may be arranged in the X-axis direction.

The liquid applying operation of each one of the liquid applying units 33 including the liquid applying units 33A, 33B, 33C, and 33D is controlled by the driving signals that are based on the printing information. When the sheet P borne on the drum 31 passes through the space facing the liquid applying device 32, the liquid applying units 33 apply multicolor liquid to the sheet P. As a result, an image based on the printing information is printed onto the sheet P.

The drier apparatus 40 includes a conveyor 41 and a drying device 42. The conveyor 41 is provided with a conveyance belt 411 looped around, for example, a driven roller and a driven roller, and puts the sheet P conveyed from the printer unit 30 on the conveyance belt 411 and conveys the sheet P. The drying device 42 is arranged above the conveyor 41, and heats the sheet P to which liquid has been applied, which is conveyed by the conveyor 41, to dry the sheet P. The sheet P is an example of an object.

Although a configuration or structure of the drying device 42 will be described later, schematically, the drying device 42 is provided with at least one heating device 43 that has a couple of heaters and a plurality of covers to cover those heaters. The covers of the heating device 43 include a couple of first covers arranged in the first direction of the heater and a couple of second covers arranged in the first direction of the heater so as to be adjacent to the first covers. A pair of first gaps whose lengths are greater than the amount of thermal deformation of either one of the first covers or the second covers or the total amount of thermal deformation of the first covers and the second covers are arranged between the first cover and the second cover. It is desired that the covers including the first covers or the second covers be made of inorganic material or metals such as aluminum (Al). Among these materials, stainless steel called steel use stainless (SUS) is desired.

The drying device 42 has a pair of supports at both ends of the heater in the first direction to support the first covers and the second covers. A pair of second gaps whose lengths are greater than the amount of thermal deformation of at least one of the first covers or the second covers are arranged between the pair of supports and both ends of each of the first cover and the second cover.

The reversing mechanism 50 has a reversing unit 51 that adopts the switchback method to reverse the sheet P when duplex printing is performed on the sheet P onto which liquid has been applied and dried in its entirety as passed through drier apparatus 40. The reversing mechanism 50 is provided with a conveyance unit 52 for duplex printing, and such a conveyance unit for duplex printing reverses the sheet P reversed by the reversing unit 51 to a point upstream from the loading barrel 34 of the printer unit 30.

The sheet ejection unit 60 is provided with an output tray 61 on which the multiple sheets P are stacked on top of each other. The sheets P that are conveyed through the reversing mechanism 50 are stacked on top of each other and held on the output tray 61.

In the present embodiment, the sheet P is described as a cut sheet cut into a predetermined size in advance. However, no limitation is indicated thereby, and the sheet P may be, for example, a long and continuous sheet such as roll sheet.

### Comparative Example

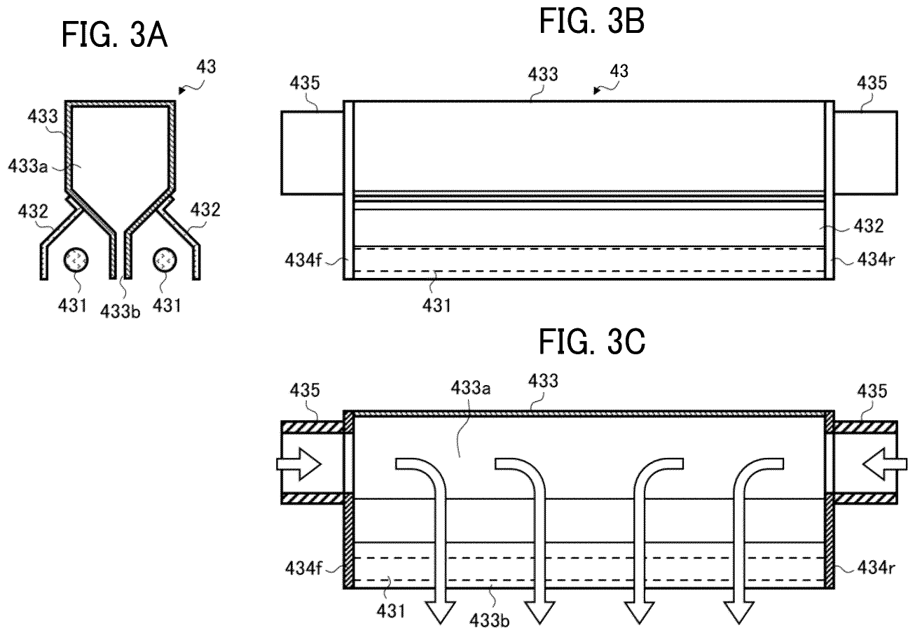

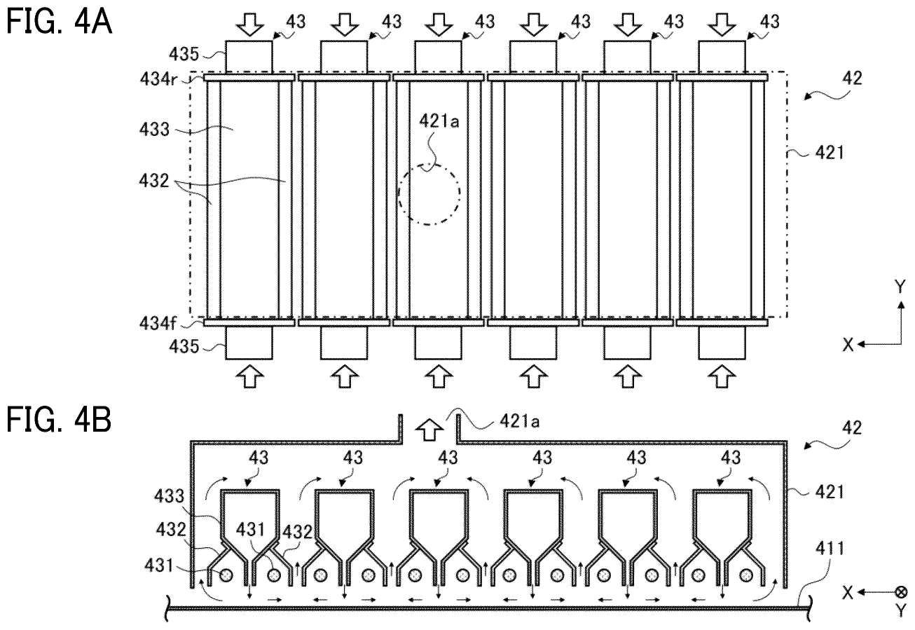

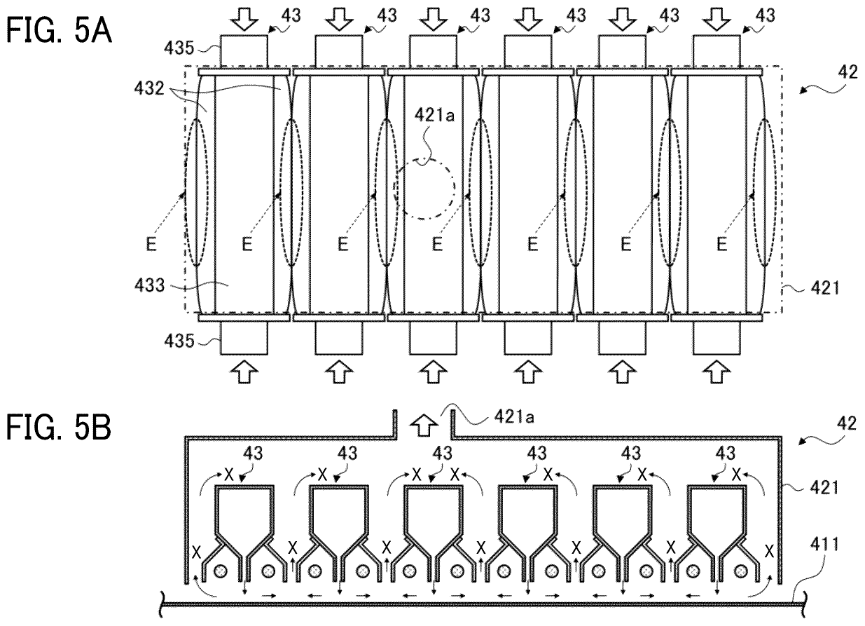

A comparative example of the embodiments of the present disclosure is described below with reference to FIG. 3A, FIG. 3B, FIG. 3C, FIG. 4A, FIG. 4B, FIG. 5A, and FIG. 5B.

FIG. 3A, FIG. 3B, and FIG. 3C are schematic diagrams each of which illustrates the heating device 43 according to a comparative example of the above embodiments of the present disclosure. FIG. 4A, FIG. 4B, FIG. 5A, and FIG. 5B are diagrams each of which illustrates the airflow inside a drying device according to a comparative example.

FIG. 3A is a schematic front view of the heating device 43 according to a comparative example.

FIG. 3B is a schematic side view of the heating device 43 of FIG. 3A.

FIG. 3C is a schematic sectional view of the air knife 433 according to a comparative example.

The heating device 43 includes a heater 431, a pair of heater covers 432, an air knife 433, a pair of side panels 434 including a front panel 434f and a rear panel 434r, and an air-intake motor 435.

The heater 431 is an infrared heater such as an infrared (IR) lamp. For example, the heater 431 is supported between the front panel 434f and the rear panel 434r. The infrared heater is, for example, a carbon heater, a tungsten heater, a halogen heater, and a ceramic heating resistor. However, no limitation is intended to those examples. The heater 431 is an example of a heater, and the longer-side direction of the heater 431 parallel to the direction from the front panel 434f to the rear panel 434r is an example of the first direction of the heater.

The heating device 43 has a pair of heaters 431, and the air knife 433 is arranged between the pair of heaters 431. Both ends of the air knife 433 in the longer-side direction are fixed to and supported by the front panel 434f and the rear panel 434r. The air knife 433 has an air passage 433a and an air outlet 433b, and the air outlet 433b is arranged between the pair of heaters 431.

A pair of air-intake motors 435 are arranged outside the front panel 434f and the rear panel 434r, and the air-intake motors 435 externally take the air into the air passage 433a as indicated by arrows in FIG. 3C. The air taken into the air passage 433a is sent to the air outlet 433b, and is sent out through the air outlet 433b.

For example, the pair of heater covers 432 are made of sheet metal that is processed into a desired shape, and a portion of each of the pair of heater covers 432 is fixed to the outer surface of the air knife 433. The pair of heaters 431 are accommodated in the space formed by a portion of the outer surface of the air knife 433 and the pair of heater covers 432.

In the drier apparatus 40 of the printer 1 described above with reference to FIG. 1, the drying device 42 is configured by arranging a plurality of heating devices 43 of the above configuration in the X-axis direction. A configuration or structure of the drying device 42 is described below.

FIG. 4A is a schematic plan view of the drying device according to a comparative example.

FIG. 4B is a schematic side sectional view of the drying device 42 of FIG. 4A.

Assuming that the X-axis direction is parallel to the conveyance direction of the sheet P in FIG. 4A and FIG. 4B, the multiple heating devices 43 are arranged in the conveyance direction of the sheet P such that the longer-side direction of the heater 431 becomes parallel to the Y-axis direction orthogonal to the X-axis direction.

The drying device 42 has a housing 421, and the multiple heating devices 43 are attached to the housing 421. For example, an outlet 421a is formed on the topside of the housing 421. An exhauster such as an exhaust motor is coupled to the outlet 421a to exhaust the air inside the housing 421 through the outlet 421a. The shape or number of the outlets 421a is not limited to the configuration or structure described with reference to FIG. 4A or FIG. 4B, but may be changed as appropriate depending on, for example, the exhaust efficiency.

When the temperature inside the housing 421 is not high in the drying device 42 of the configuration or structure as described above, as described with reference to FIG. 4B, the air that is blown from the air knife 433 to the conveyance belt 411 contacts the conveyance belt 411 and changes its direction to the lateral direction (i.e., the right and left directions in FIG. 4B). Then, the air goes upward as passing through the space between pairs of the heater covers 432 of neighboring pairs of the heating devices 43, and is exhausted through the outlet 421a.

However, when the temperature inside the housing 421 gets high, the airflow as described above may be lost. The airflow when the temperature inside the housing 421 is high is described below.

FIG. 5A is a schematic plan view of the drying device 42 according to a comparative example.

FIG. 5B is a schematic side sectional view of the drying device 42 of FIG. 5A.

When the temperature inside the housing 421 is high, the pair of heater covers 432 is deformed due to thermal expansion, and as indicated by broken lines E in FIG. 5A, the spacing among the heater covers 432 significantly decreases in the central portion of the heating device 43 in the longer-side direction. As a result, the airflow gets worsened at areas indicated by X in FIG. 5B, and hot air tends to stay or build up in the central portion of the heating device 43 in the longer-side direction.

If the hot air stays or builds up in the central portion of the heating device 43 in the longer-side direction, the temperature inside the drying device 42 becomes unstable. For example, the temperature at the central portion tends to be excessively higher than that of the ends when the temperature of the drying device 42 is to be controlled, and the detection of temperature may end in failure. In such cases, control cannot accurately be done.

### First Embodiment

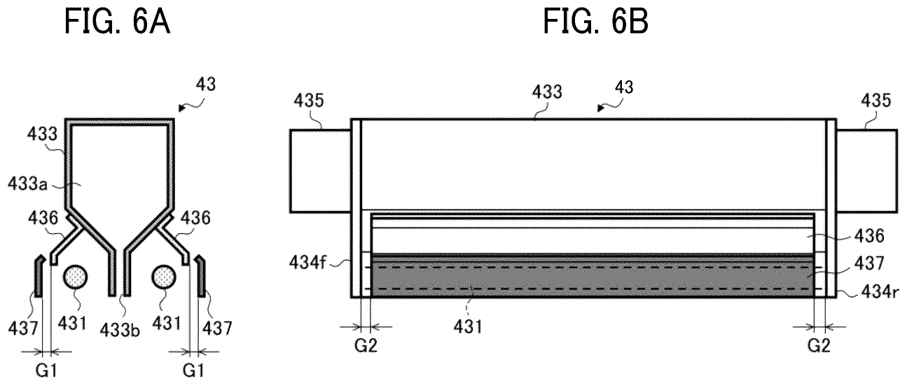

FIG. 6A is a schematic front view of the heating device 43 according to the first embodiment of the present disclosure.

FIG. 6B is a schematic side view of the heating device 43 of FIG. 6A, according to the first embodiment of the present disclosure.

In the description of the first embodiment, like reference signs are given to elements similar to those described in the above comparative example, and overlapping description may be omitted.

The first embodiment of the present disclosure is different from the above comparative example in that the heater cover is divided into a pair of first heater covers 436 and a pair of second heater covers 437.

As illustrated in FIG. 6B, the pair of first heater covers 436 are arranged in the longer-side direction of the heater 431. In a similar manner, the pair of second heater covers 437 are arranged in the longer-side direction of the heater 431, and each of the pair of second heater covers 437 is adjacent to the corresponding one of the pair of the first heater covers 436. The pair of first heater covers 436 is an example of a first cover, and the pair of second heater covers 437 is an example of a second cover.

As illustrated in FIG. 6A, a gap G1 is arranged at an area where each of the pair of first heater covers 436 and corresponding one of the pair of second heater covers 437 are adjacent to each other. The pair of gaps G1 have a length greater than the amount of thermal deformation such that each of the pair of first heater covers 436 and corresponding one of the pair of second heater covers 437 do not contact each other when those covers are deformed due to the thermal expansion caused by the heat generated by the heating device 43. The pair of gaps G1 are designed to have an appropriate value based on the specification of the heater covers such as the material, shape, and heating temperature.

As illustrated in FIG. 6B, a pair of gaps G2 are arranged between the front panel 434f and ends of the pair of first heater covers 436 and between the rear panel 434r and the other ends of the pair of first heater covers 436, in the longer-side direction of the heater 431. In a similar manner to the above, the pair of gaps G2 are arranged between the front panel 434f and one end of the second heater cover 437 and between the rear panel 434r and another end of the second heater cover 437. The pair of gaps G2 have a length greater than the amount of thermal deformation such that the ends of each of the heater covers do not contact the side panels 434 when any one of the pair of first heater covers 436 and the pair of second heater covers 437 is deformed in shape due to the thermal expansion caused by the heat generated by the heating device 43. The pair of gaps G2 are also designed to have an appropriate value based on the specification of the heater covers such as the material, shape, and heating temperature.

In the present embodiment, the front panel 434f and the rear panel 434r are made of a material with low thermal deformation such as a galvanized steel sheet (e.g., SECC-NC E16/E16). In such a configuration where the front panel 434f and the rear panel 434r barely deform due to heat, it is satisfactory as long as the pair of gaps G2 are designed to have a length greater than the amount of thermal deformation of at least one of the pair of first heater covers 436 or the pair of second heater covers 437. When a material with which thermal deformation is not ignorable is used for the front panel 434f and the rear panel 434r, the size of the gaps G2 is to be designed in view of the amount of thermal deformation at the front panel 434f and the rear panel 434r. In other words, it is desired that the gaps G2 under such circumstances have a length greater than that of the total amount of thermal deformation of the front panel 434f and the rear panel 434r and at least one of the pair of first heater covers 436 or the pair of second heater covers 437.

The pair of gaps G2 can be formed by fixing or attaching the first and second heater covers 436 and 437 to the pair of side panels 434 using a spacer therebetween whose thickness is equivalent to a desired thickness for the gaps G2 between the side panel 434 and the first and second heater covers 436 and 437 or using a stepped screw. The pair of gaps G1 and the pair of gaps G2 are examples of the first gap and the second gap, respectively. Each one of the front panel 434f and the rear panel 434r is an example of a support.

The heating device 43 includes a pair of heaters 431, and the air knife 433 is arranged between the pair of heaters 431. Both ends of the air knife 433 in the longer-side direction are fixed to and supported by the front panel 434f and the rear panel 434r. The air knife 433 has an air passage 433a and an air outlet 433b, and the air outlet 433b is arranged between the pair of heaters 431.

A pair of air-intake motors 435 are arranged outside the front panel 434f and the rear panel 434r, and the air-intake motors 435 externally take the air into the air passage 433a. The air taken into the air passage 433a is sent to the air outlet 433b, and is sent out through the air outlet 433b. The air knife 433 is an example of an air applicator.

The pair of first heater covers 436 have portions fixed to the outer surface of the air knife 433. The pair of heaters 431 are accommodated in the space formed by a portion of the outer surface of the air knife 433, the pair of first heater covers 436, and the pair of second heater covers 437A.

As described above, in the present embodiment, the pair of heaters 431 and covers that cover the heaters 431 are provided, and the covers include the first heater covers 436 arranged in the longer-side direction of the heaters 431 and the second heater covers 437 arranged in the longer-side direction of the heaters 431 so as to be adjacent to the first heater covers 436. Moreover, the pair of gaps G1 whose length is greater than the amount of thermal deformation of either one of the first cover or the second cover or the total amount of thermal deformation of the first covers and the second covers are arranged between the first heater cover 436 and the second heater cover 437.

Due to such a configuration, the deformation due to the thermal deformation of the first heater covers 436 and the second heater covers 437 is absorbed by the gaps G1, and the interference between the first heater covers 436 and the second heater covers 437 can be prevented. For example, the second heater covers 437 do not easily expand or stick out to the outside of the heating device 43 due to the interference between the first heater covers 436 and the second heater covers 437.

As described above, the pair of side panels 434 including the front panel 434f and the rear panel 434r that support the pair of first heater covers 436 and the pair of second heater covers 437 are arranged at both ends of the heater 431 in the longer-side direction, and a pair of gaps G2 whose length is greater than the amount of thermal deformation of at least one of the first covers or the second covers are arranged between the pair of side panels 434 and both ends of the first heater covers 436 and the second heater covers 437.

Due to such a configuration, the deformation due to the thermal deformation caused by the first heater covers 436 and the second heater covers 437 is absorbed by the gaps G2, and the interference between the pair of side panels 434 and the first heater covers 436 and the second heater covers 437 can be prevented. For example, the pair of first heater covers 436 and the second heater covers 437 do not easily expand or stick out to the outside of the heating device 43 due to the interference between the pair of side panels 434 and both ends of each of the pair of first heater covers 436 and the pair of second heater covers 437 in the longer-side direction.

The heating device 43 is provided with an air knife 433 that applies air, and the pair of first heater covers 436 have portions fixed to the air knife 433. The pair of heaters 431 are arranged in the space formed by the outer surface of the air knife 433, the pair of first heater covers 436, and the pair of second heater covers 437.

Due to such a configuration, both the downsizing of the heating device 43 provided with air knife 433 and the prevention of interference among members or elements due to thermal deformation can be achieved.

The heating device 43 according to the present embodiment is applicable to the drying device 42, as described above with reference to FIG. 4A or FIG. 4B, which dries an object such as the sheet P to which liquid is applied.

According to such a configuration, a drying device in which the airflow inside the housing 421 is stabilized and desired heating performance is maintained can be provided.

Moreover, the heating device 43 according to the present embodiment is applicable to a liquid discharge apparatus such as the printer 1 as illustrated in FIG. 1 provided with the liquid applying device 32 that applies the liquid to the sheet P and the drying device 42 used to dry the sheet P.

Due to such a configuration, a liquid applying apparatus in which the drying performance of the drying device 42 is stable and desired liquid application quality is maintained can be provided.

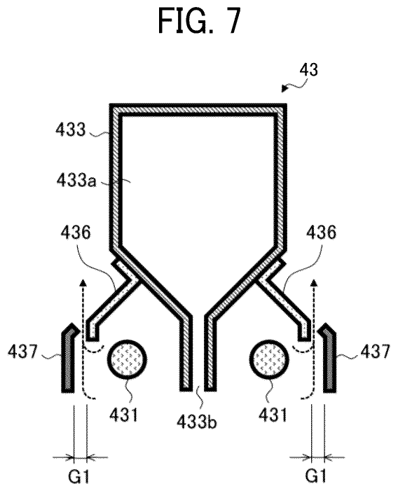

In the case of the first embodiment, as indicated by arrows with broken lines in FIG. 7, the heated air tends to escape from the pair of gaps G1 arranged between the pair of first heater covers 436 and the pair of second heater covers 437. An embodiment to reduce such an air escape is described below.

### Second Embodiment

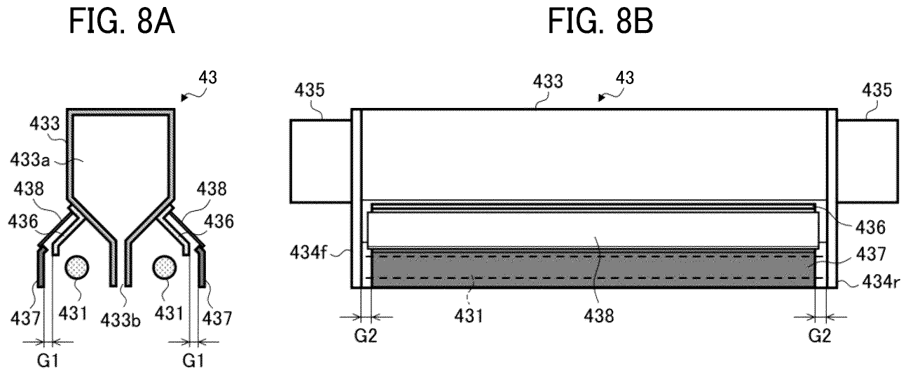

FIG. 8A is a schematic front view of a heating device 43 according to the second embodiment of the present disclosure.

FIG. 8B is a schematic side view of the heating device 43 of FIG. 8A, according to the second embodiment of the present disclosure.

In the description of the second embodiment, like reference signs are given to elements similar to those described in the above comparative example or the first embodiment, and overlapping description may be omitted.

The second embodiment is different from the first embodiment in the respect that a pair of flaps 438 are arranged above the pair of gaps G1.

The pair of flaps 438 are arranged at the rear of the pair of first heater covers 436 when viewed from the pair of heaters 431 such that the radiant heat of the pair of heaters 431 does not directly strike the pair of flaps 438. Due to such a configuration, the flap 438 is not heated in an undesired manner, and the thermal expansion of the flap 438 can be reduced. The flap 438 is an example of a lid.

Each one of the pair of flaps 438 is, for example, a rectangular sheet, and one end of each one of the pair of flaps 438 in the shorter-side direction is supported by corresponding one of the pair of first heater covers 436. The other end of each one of the pair of flaps 438 in the shorter-side direction only touches the corresponding one of the pair of second heater covers 437, and is not fixed to the corresponding one of the pair of second heater covers 437. If the flaps 438 are fixed to the second heater covers 437, there is a concern that the thermal deformation of the pair of flaps 438 affect the pair of second heater covers 437.

The solidity or rigidity of the pair of flaps 438 is made lower than the solidity or rigidity of the pair of second heater covers 437 such that the pair of flaps 438 are movable in response to the thermal deformation of the pair of second heater covers 437. In the present embodiment, the thickness of the pair of flaps 438 is made thinner than the thickness of the pair of second heater covers 437. For example, stainless steel of 1 millimeter (mm) thickness is used for the pair of second heater covers 437, and stainless steel of 0.5 mm thickness is used for the pair of flaps 438.

In the configuration or structure as described above, one end of each of the pair of flaps 438 is supported by corresponding one of the pair of first heater covers 436. However, no limitation is indicated thereby, and one end of each of the pair of flaps 438 may be supported by, for example, the outer surface of the air knife 433.

As described above, each pair of heater covers according to the present embodiment is provided with the flap 438 above the gap G1.

Due to such a configuration, both the reduction of the air escape from the pair of gaps G1 and the prevention of the interference between the first heater covers 436 and the second heater covers 437 due to thermal deformation can be achieved.

### Modification

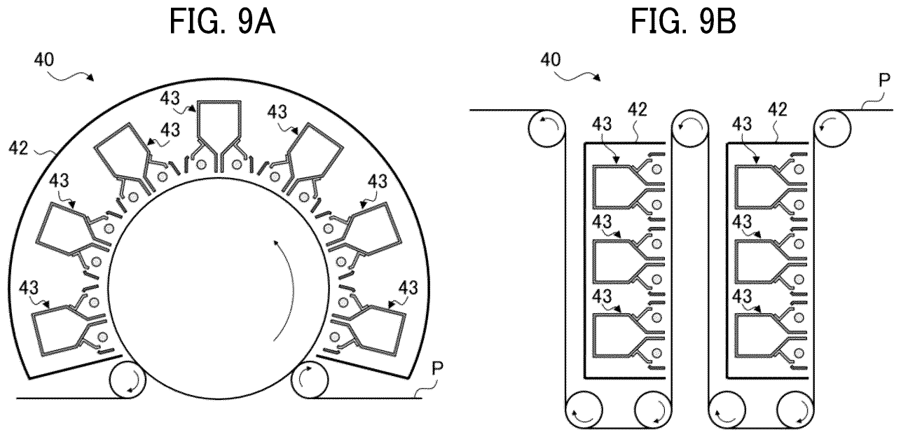

FIG. 9A and FIG. 9B are schematic diagrams each of which illustrates the drier apparatus 40 according to a modification of the above embodiments of the present disclosure.

In the printer 1 described above with reference to FIG. 1, the drier apparatus 40 uses the drying device 42 to dry the surface of the sheet P while the sheet P is being conveyed horizontally in the X-axis direction using the conveyor 41. However, the way of conveying the sheet P for the drier apparatus 40 is not limited to the above.

For example, as illustrated in FIG. 9A, the sheet P to which liquid has been applied may be looped around a drum used for drying, and the sheet P may be dried by the drying device 42 while the sheet P is being conveyed.

In the drying device 42 according to the present modification, the multiple heating devices 43 according to the first or second embodiment of the present disclosure are arranged around the drum used for drying.

For example, as illustrated in FIG. 9B, the sheet P may be dried by the multiple drying devices 42 disposed at some midpoint while the sheet P to which liquid has been applied is being conveyed horizontally in the up and down directions in a meandering manner.

In the drying device 42 according to the present modification, the multiple heating device 43 according to the first or second embodiment of the present disclosure are arranged along the conveyance path of the sheet P.

According to the above modification of the above embodiments of the present disclosure, the distance of the drying operation can be increased without increasing the length of the drier apparatus 40 in the X-axis direction to an excessive degree.

### Supplemental Information

In the embodiments of the present disclosure, the liquid applying apparatus is an apparatus that has heads to apply liquid and drives the heads to apply the liquid. The liquid applying apparatus is not limited to an apparatus used to apply a liquid to an object to which liquid can adhere, and may be an apparatus used to apply a liquid into the air or a different liquid.

The liquid applying apparatus, is for example, a device that relates to the feeding, conveying, and discharging of an object to which liquid can adhere. Alternatively, the liquid applying apparatus may be, for example, a pretreatment device and a post-processing apparatus such as a sheet processing apparatus. The liquid applying apparatus may be, for example, an image forming apparatus that applies ink to a sheet to form an image thereon, or a three-dimensional object forming apparatus that applies molding liquid to the powder layer made of layered granular materials so as to form a three-dimensional object.

The liquid applying apparatus is not limited to an apparatus that applies liquid to visualize images with some meaning such as letters or figures. For example, the liquid applying apparatus may be an apparatus that forms images with no meaning in themselves such as meaningless patterns or an apparatus that fabricates three-dimensional images.

The term “object to which liquid can adhere” as above denotes, for example, an object to which liquid can at least temporarily adhere, an object to which liquid adheres and is fixed, and an object to which liquid adheres and permeates. Examples of the “object to which liquid can adhere” include, but are not limited to, a recording medium such as a sheet of paper, a recording sheet, a film, and a cloth, an electronic component such as an electronic substrate or a piezoelectric element, and a medium such as a powder layer, an organ model, or a cell for testing. In other words, the “object to which liquid can adhere” may be any object to which liquid can adhere unless otherwise specified.

The material of the “object to which liquid can adhere” as above may be, for example, paper, thread, fiber, fabric, leather, metal, plastic, glass, wood, and ceramic, charge collector such as aluminum foil and copper foil, or electrode in which a layer of active material is formed on a charge collector. In other words, the “object to which liquid can adhere” is satisfactory as long as a liquid can adhere thereto even on a temporary basis.

The term “liquid” may be any substance as long as it has viscosity or surface tension and can be applied through the head, and is not limited to any particular liquid. It is desired that the viscosity of the liquid be equal to or lower than 30 millipascal-second (mPa s) under normal temperature and normal atmospheric pressure or by heating or cooling. More specifically, the liquid according to the embodiments of the present disclosure may be, for example, a solution, a suspension, and an emulsion including a solvent such as water and an organic solvent, colorants such as dyes and pigments, high-performance materials or functional materials such as a polymerized compound, a resin, and a surfactant, biomaterials such as deoxyribonucleic acid (DNA), amino acids, proteins, and calcium, edible ingredients such as natural coloring agents, active materials or solid electrolytes used as electrode materials, ink with conductive materials or insulative materials. For example, such a solution, a suspension, or an emulsion may be used for ink for inkjet printing, a surface treatment solution, a liquid for forming components of an electronic element or light-emitting element, a liquid for forming a resist pattern of an electronic circuit, a material liquid used to form a three-dimensional object, an electrode, or an electrochemical element.

The “liquid applying apparatus” may be an apparatus in which the head is moved relative to an object to which liquid can adhere, but no limitation is intended thereby. Examples of the liquid applying apparatus include a serial device in which the head is moved and a line device in which the head is not moved.

Examples of the liquid applying apparatus further include a treatment liquid coating apparatus to discharge a treatment liquid to a sheet to coat the treatment liquid on a sheet surface to reform the sheet surface and an injection granulation apparatus in which a composition liquid including raw materials dispersed in a solution is discharged through nozzles to granulate fine particles of the raw materials.

Note that numerous additional modifications and variations are possible in light of the above teachings. It is therefore to be understood that within the scope of the appended claims, the embodiments of the present disclosure may be practiced otherwise than as specifically described herein. For example, elements and/or features of different illustrative embodiments may be combined with each other and/or substituted for each other within the scope of this disclosure and appended claims.

### First Aspect

A heating device according to the first aspect of the present disclosure includes a heater such as the heater 431, and a cover to cover the heater. In the heating device, the cover includes a first cover such as the first heater cover 436 disposed in a first direction of the heater such as the longer-side direction of the heater 431 and a second cover such as the second heater cover 437 disposed in the first direction, and the second cover is adjacent to the first cover. In the heating device, the first cover and the second cover have a first gap such as the gap G1 in between, and the first gap has a length greater than an amount of thermal deformation of either one of the first cover or the second cover or a total amount of thermal deformation of the first cover and the second cover.

### Second Aspect

The heating device according to the first aspect further includes a support such as the front panel 434f and the rear panel 434r at both ends of the heater in the first direction to support the first cover and the second cover, and the support and both ends of each of the first cover and the second cover have a second gap such as the gap G2 in between, and the second gap has a length greater than an amount of thermal deformation of at least one of the first cover or the second cover.

### Third Aspect

In the heating device according to the first aspect or the second aspect, the cover includes a lid such as the flap 438 disposed above the first gap.

### Fourth Aspect

The heating device according to the first aspect or the second aspect further includes an air applicator such as the air knife 433 to apply air. The first cover has a portion fixed to the air applicator, and the heater is disposed in space formed by an outer surface of the air applicator, the first cover, and the second cover.

### Fifth Aspect

The heating device according to the third aspect includes an air applicator such as the air knife 433 to apply air. The first cover has a portion fixed to the air applicator, and the heater is disposed in space formed by an outer surface of the air applicator, the first cover, and the second cover.

### Sixth Aspect

A drying device such as the drying device 42 according to the sixth aspect of the present disclosure dries an object such as the sheet P to which liquid is applied, and includes the multiple heating device according to the first or second aspect of the present disclosure.

### Seventh Aspect

An apparatus according to the seventh aspect of the present disclosure is a liquid applying apparatus such as the printer 1 including a liquid applicator such as the liquid applying device 32 to apply a liquid to an object such as the sheet P, and the heating device according to the first or second aspect of the present disclosure that heats the object.

### Eighth Aspect

An apparatus according to the eighth aspect of the present disclosure is a liquid applying apparatus such as the printer 1 including a liquid applicator such as the liquid applying device 32 that applies liquid to an object such as the sheet P, and the drying device according to the sixth aspect that dries the object.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application-specific integrated circuit (ASIC), digital signal processor (DSP), field-programmable gate array (FPGA), and conventional circuit components arranged to perform the recited functions.

What is claimed is:

1. A heating device comprising:
a heater; and
a cover to cover the heater,
the cover including
a first cover disposed in a first direction of the heater and
a second cover disposed in the first direction, the second cover being adjacent to the first cover,
the first cover and the second cover having a gap in between,
the gap having a length greater than an amount of thermal deformation of either one of the first cover or the second cover or a total amount of thermal deformation of the first cover and the second cover.

2. The heating device according to claim 1, further comprising
a support at both ends of the heater in the first direction to support the first cover and the second cover,
wherein the support and both ends of each of the first cover and the second cover have another gap in between, and
wherein said another gap has a length greater than an amount of thermal deformation of at least one of the first cover or the second cover.

3. The heating device according to claim 1,
wherein the cover includes a lid disposed above the gap.

4. The heating device according to claim 1, further comprising
an air applicator to apply air,
wherein the first cover has a portion fixed to the air applicator, and
wherein the heater is disposed in space formed by an outer surface of the air applicator, the first cover, and the second cover.

5. The heating device according to claim 3, further comprising
an air applicator to apply air,
wherein the first cover has a portion fixed to the air applicator, and
wherein the heater is disposed in space formed by an outer surface of the air applicator, the first cover, and the second cover.

6. A drier apparatus comprising:
a drying device to dry an object to which liquid has been applied; and
a plurality of heating devices each of which includes
a heater, and
a cover to cover the heater,
the cover including
a first cover disposed in a first direction of the heater and
a second cover disposed in the first direction, the second cover being adjacent to the first cover,
the first cover and the second cover having a gap in between,
the gap having a length greater than an amount of thermal deformation of either one of the first cover or the second cover or a total amount of thermal deformation of the first cover and the second cover.

7. A liquid applying apparatus comprising:
a liquid applicator to apply a liquid to an object; and
a heating device to heat the object, the heating device including
a heater, and
a cover to cover the heater,
the cover including
a first cover disposed in a first direction of the heater and
a second cover disposed in the first direction, the second cover being adjacent to the first cover,
the first cover and the second cover having a gap in between,
the gap having a length greater than an amount of thermal deformation of either one of the first cover or the second cover or a total amount of thermal deformation of the first cover and the second cover.

8. A liquid applying apparatus comprising:
a liquid applicator to apply a liquid to an object; and
the drier apparatus according to claim 6 to dry the object.
